(19) United States
(12) Patent Application Publication
(10) Pub. No.: US 2014/0356600 A1
(43) Pub. Date: Dec. 4, 2014

(54) SURFACE-PROTECTING SHEET AND PRODUCING METHOD THEREOF

(71) Applicant: Samsung Display Co., Ltd., Yongin-City (KR)

(72) Inventors: Yuki HONGO, Yongin-City (KR); Mikiya ITAKURA, Yongin-City (KR); Ju-Suk OH, Yongin-City (KR); Kwan-Young HAN, Yongin-City (KR)

(73) Assignee: Samsung Display Co., Ltd., Yongin-City (KR)

(21) Appl. No.: 14/109,661

(22) Filed: Dec. 17, 2013

(30) Foreign Application Priority Data
Jun. 4, 2013 (KR) 10-2013-0064156

(51) Int. Cl. C09D 135/02; B05D 3/06

(52) U.S. Cl. CPC C09D 135/02; B05D 3/067
USPC 428/215; 427/508

(57) ABSTRACT

A surface-protecting sheet is provided that includes a first plastic substrate including a thermoplastic resin and (meth)acrylic acid ester and a second plastic substrate disposed on one side of the first plastic substrate, wherein the first plastic substrate has a thickness of about 0.5 μm to about 25 μm, and the second plastic substrate has a thickness of about 10 μm to about 200 μm.

### RELATED APPLICATIONS

This application claims priority to and the benefit of Korean Patent Application No. 10-2013-0064156 filed in the Korean Intellectual Property Office on Jun. 4, 2013, the entire contents of which are incorporated herein by reference.

### BACKGROUND

1. Field

A surface-protecting sheet and a producing method thereof are disclosed.

2. Description of the Related Art

Currently known display devices include a liquid crystal display (LCD), a plasma display panel (PDP), an organic light emitting diode display (OLED), a field effect display (FED), an electrophoretic display device, and the like.

Such display devices include a display module displaying image and a window protecting the display module.

The window includes a surface-protecting sheet, and such a surface-protecting sheet may be made of glass.

However, because glass can be easily broken by external impact, when glass is used for portable devices, such as mobile phones, it may be easily damaged. Therefore, recently, a surface-protecting sheet made of plastic material instead of glass is being researched.

As a display device having a touch screen function is used, a hand or a sharp tool, such as a pen, may frequently contact one side of the window. In this case, a window that is made of plastic may be easily scratched on the surface. In addition, a window that is made of plastic may undergo appearance deformation such as curl or waiving.

### SUMMARY

A surface-protecting sheet is provided that prevents appearance deformation while improving surface hardness and adherence. The surface-protection sheet may be included on a window. The surface-protecting sheet may be included on a display device.

According to an aspect, a surface-protecting sheet includes a first plastic substrate including a thermoplastic resin and (meth)acrylic acid ester and a second plastic substrate disposed on one side of the first plastic substrate, wherein the first plastic substrate has a thickness of about 0.5 μm to about 25 μm, and the second plastic substrate has a thickness of about 10 μm to about 200 μm.

The (meth)acrylic acid ester may be included in an amount of about 5 wt % to about 40 wt % based on the weight of the first plastic substrate.

The (meth)acrylic acid ester may be included in an amount of about 5 wt % to about 30 wt % based on the weight of the first plastic substrate.

The second plastic substrate may include an ultraviolet (UV) curable resin.

The second plastic substrate may be a hard coating layer.

The second plastic substrate may include (meth)acrylic acid ester.

The second plastic substrate may include an inorganic particle.

The inorganic particle may have a particle diameter of greater than or equal to about 10 nm and less than or equal to about 100 nm.

The thermoplastic resin may be polyethylene, polystyrene, polyethylene terephthalate, polyvinyl chloride, polyvinylidene chloride, a copolymer thereof, or a combination thereof.

An adhesive layer may be formed on a side of the first plastic substrate opposite a side facing the second plastic substrate.

The surface-protecting sheet may have a surface haze of less than about 1.0%.

A window for a display device including the surface-protecting sheet may be provided.

A display device including the surface-protecting sheet may be provided.

According to another aspect, a method of producing a surface-protecting sheet includes preparing a first coating liquid including a thermoplastic resin and (meth)acrylic acid ester, coating the first coating liquid on one side of a release film and drying the same to form a first plastic substrate, coating a second coating liquid including (meth)acrylic acid ester on the first plastic substrate followed by drying the same and radiating ultraviolet (UV) to form a second plastic substrate, and removing the release film.

The first coating liquid and the second coating liquid may be coated using a solution casting method.

The first plastic substrate may be formed in a thickness of about 0.5 μm to about 25 μm, and the second plastic substrate may be formed in a thickness of about 10 μm to about 200 μm.

The surface-protecting sheet prevents appearance deformation while improving surface hardness and adherence.

### BRIEF DESCRIPTION OF THE DRAWINGS

FIG. 1 is a cross-sectional view of a surface-protecting sheet according to an example embodiment.

FIG. 2 is a flow chart illustrating a method of manufacturing a surface-protecting sheet according to an example embodiment.

FIG. 3 is a cross-sectional view of a surface-protecting sheet included in a display device according to an example embodiment.

### DETAILED DESCRIPTION

Hereinafter, example embodiments will be described in detail so that a person skilled in the relevant art would understand. The disclosure may, however, be embodied in many different forms and is not construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it may be directly on the other element, or intervening elements may also be present. In contrast, when an element is referred to as being “directly on” another element, there are no intervening elements present.

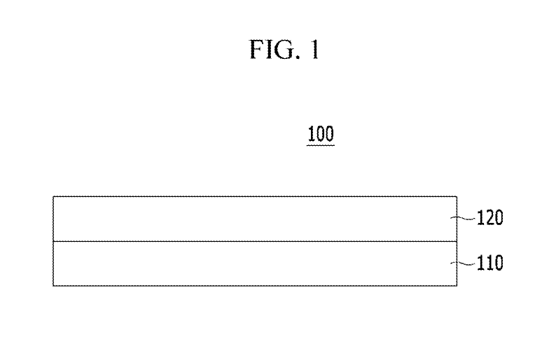

Referring to FIG. 1, a surface-protecting sheet according to an example embodiment will be described.

FIG. 1 is a cross-sectional view of a surface-protecting sheet according to an example embodiment.

Referring to FIG. 1, a surface-protecting sheet 100 according an example embodiment includes a first plastic substrate 110 and a second plastic substrate 120 disposed on one side of the first plastic substrate 110.

The first plastic substrate 110 supports the surface-protecting sheet 100, and includes, for example, a thermoplastic resin and (meth)acrylic acid ester.

The thermoplastic resin is not limited to specific kind of thermoplastic resin, and non-limiting examples of the thermoplastic resin that may be used in the first plastic substrate 110 include polyethylene, polystyrene, polyethylene terephthalate, polyvinyl chloride, polyvinylidene chloride, a copolymer thereof, or a combination thereof.

The first plastic substrate 110 includes (meth)acrylic acid ester as well as the thermoplastic resin.

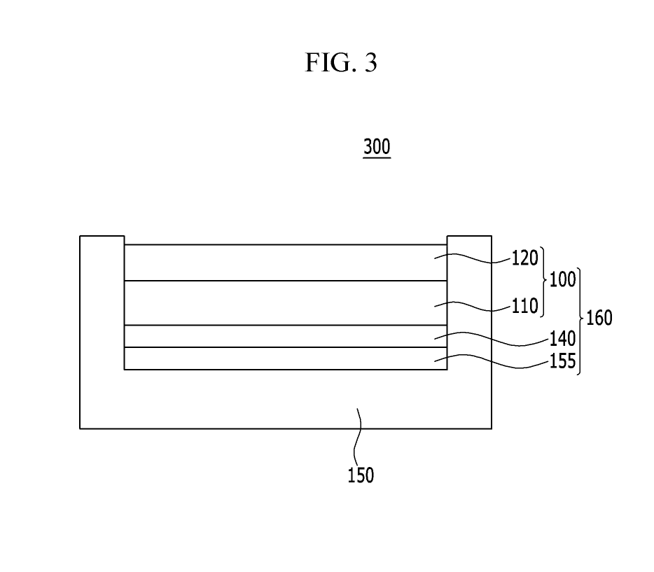

The surface-protecting sheet 100 may, for example, be bonded with a window mother material layer as described below with reference to FIG. 3. An adhesive layer may be positioned between the window mother material layer and the surface-protection sheet 100. For example, the adhesive layer is formed on the other side of the first plastic substrate 110. The adhesive layer may include, for example, OCA (Optical Clear Adhesive).

The second plastic substrate 120 may be a hard coating layer. The surface-protecting sheet 100 includes the second plastic substrate 120 and thus, may protect a device from an external impact such as a scratch and the like on the surface thereof.

The second plastic substrate 120 may include an ultraviolet (UV) curable resin, and the kind of the UV-curable resin used is not limited.

The second plastic substrate 120 may include, for example, (meth)acrylic acid ester but is not limited thereto and may include a material having high hardness and light transmittance.

The second plastic substrate 120 may further include an additive to the ultraviolet (UV) curable resin.

The second plastic substrate 120 may further include, for example, a photopolymerization initiator as well as the ultraviolet (UV) curable resin. The photopolymerization initiator may include, for example, an acetophenone-based compound or a benzophenone-based compound but is not limited thereto.

The second plastic substrate 120 may include, for example, an inorganic particle. The inorganic particle may be, for example silica, alumina, mica, glass beads, titania, iron oxide, or a combination thereof. Among the materials, the silica may provide the most light transmittance.

The particle diameter of the inorganic particle is not limited, and may be, for example, greater than or equal to about 10 nm and less than or equal to about 100 nm.

As described above, the first plastic substrate 110 includes a thermoplastic resin and (meth)acrylic acid ester.

Herein, the (meth)acrylic acid ester may be included in an amount of about 5 wt % to about 40 wt % and specifically about 5 wt % to about 30 wt % based on the weight of the first plastic substrate 110. When the (meth)acrylic acid ester is included within the range, surface hardness and adherence of the surface-protecting sheet 100 may be improved. In addition, even when the surface-protecting sheet 100 is adhered to a curled surface, a curl may not be generated thereon.

The first plastic substrate 110 may have a thickness of about 0.5 μm to about 25 μm, and the second plastic substrate 120 may have a thickness of about 10 μm to about 200 μm. When the first and second plastic substrates 110 and 120 respectively have a thickness within these ranges, a display panel may not only be sufficiently protected but a display device may also be manufactured to be thin.

The surface-protecting sheet 100 may have a surface haze of less than about 1.0%. Herein, the haze is measured by using a hazemeter (NDH-5000, Nippondenshoku Industries Co., Ltd.). When the haze is within this range, appropriate visibility may be secured.

According to an example embodiment, a surface-protecting sheet may have optically isotropic characteristics. Accordingly the surface-protecting sheet has no substantial birefringence for light, and thus may be applied to a product using polarized light.

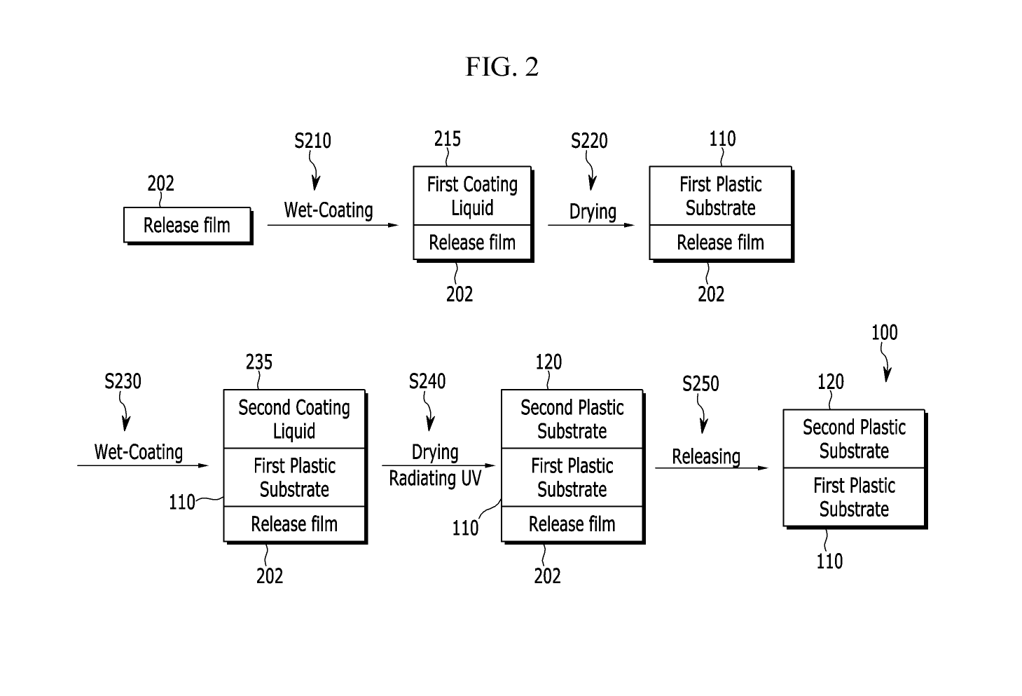

According to another example embodiment, a method of producing a surface-protecting sheet is provided. FIG. 2 is a flow chart illustrating a method of manufacturing a surface-protecting sheet according to an example embodiment.

Referring to FIG. 2, a method for producing a surface protecting sheet includes providing a release film 202 on which the surface-protecting sheet is manufactured. The release film 202 may be, for example, a film including a PET film and a silicon coating layer disposed on the PET film. The method includes preparing a first coating liquid 215 that includes a thermoplastic resin and (meth)acrylic acid ester, and wet-coating S210 the first coating liquid 215 on one side of a release film 202. The first coating liquid 215 wet-coated onto release film 202 is dried S220 to form a first plastic substrate 110. A second coating liquid 235 including (meth)acrylic acid ester is wet-coated S230 onto the first plastic substrate 110. The second coating liquid 235 wet-coated onto the first plastic substrate 110 is dried and irradiated with ultraviolet (UV) light S240 to form a second plastic substrate 120. The first plastic substrate 110 combined with second plastic substrate 120 are then released and removed S250 from the release film to form surface protecting sheet 100. Surface protecting sheet 100 may be adhered to a display device.

A method of coating the first and second coating liquids at S210 and S230 has no particular limit but may include, for example, a solution casting method. The solution casting method may form a coating layer having a desired thickness and, simultaneously, decrease an in-phase phase difference inside the surface.

The first plastic substrate 110 may be, for example formed to a thickness of about 0.5 μm to about 25 μm, and the second plastic substrate 120 may be, for example formed to a thickness of about 10 μm to about 200 μm, but they are not limited thereto.

According to another example embodiment, a window including the surface-protecting sheet is provided.

According to another example embodiment, a display device including the surface-protecting sheet is provided.

The surface-protecting sheet may be used with various display devices. The display device on which the surface-protecting sheet is employed may include, for example, a liquid crystal display (LCD), an organic light emitting diode (OLED) display, a plasma display, an electric field effect display device, an electrophoresis display device, and the like, but is not limited thereto.

FIG. 3 illustrates an example embodiment of a surface protecting sheet 100 included in a display device 300. The surface-protecting sheet 100 may be bonded with a window mother material layer 155. An adhesive layer 140 may be positioned between the window mother material layer 155 and the surface-protection sheet 100. For example, the adhesive layer 140 is formed on the side of the first plastic substrate 110 facing the device module 150. The adhesive layer 140 may include, for example, an OCA as discussed above. The display device 300 includes the window 160 on which images are display. The window 160 may include the window mother material layer 155, which may be formed, for example of, glass or plastic. The adhesive layer 140 and surface-protecting sheet 100 are disposed on the window mother material layer 155, and may be disposed on the window mother material layer 155 before or after the window mother material layer 155 is disposed in the display device 300.

Hereinafter, the present disclosure is illustrated in more detail with reference to examples. However, the present disclosure is not limited to these examples.

### Production of Surface-Protecting Sheet

### Example 1

A first coating liquid was prepared by mixing a thermoplastic resin (Vylon UR5537, TOYOBO Co., Ltd.) and pentaerythritol triacrylate (NK ESTER A-TMM-3L, Shin-Nakamura Chemical Co., Ltd.). The pentaerythritol triacrylate was used in an amount of 5 wt % based on the amount of the first coating liquid.

The first coating liquid was wet-coated to be 5 μm thick on a release film using a solution casting method and dried by blowing a 90° C. wind for one minute to form a first plastic substrate.

A second coating liquid was prepared by diluting an ultraviolet (UV) curable resin (Opster KZ6445A, JSR Co.) with a solvent.

Subsequently, the second coating liquid was wet-coated to be 15 μm thick on the first plastic substrate in a solution casting method and dried by blowing a 90° C. wind for 2 minutes and then, radiating an ultraviolet (UV) ray (dose: 500 mJ/cm²) under a nitrogen atmosphere, forming a second plastic substrate.

Subsequently, the release film was removed, manufacturing a surface-protecting sheet.

### Example 2

A surface-protecting sheet was manufactured according to the same method as Example 1 except for coating the first coating liquid to be 15 μm thick.

### Example 3

A surface-protecting sheet was manufactured according to the same method as Example 1 except for using TA-100 (TOA Gosei Co.) instead of the Opster KZ6445A (JSR Co.) as the second coating liquid component and coating the second coating liquid to be 70 μm thick.

### Example 4

A surface-protecting sheet was manufactured according to the same method as Example 1 except for using the pentaerythritol triacrylate in an amount of 30 wt % based on the amount of the first coating liquid.

### Comparative Example 1

The second coating liquid according to Example 1 was wet-coated to be 15 μm thick on a 5 μm-thick polyethylene terephthalate (PET) film and dried by blowing a 90° C. wind for 2 minutes. Subsequently, a surface-protecting sheet was manufacture by radiating an ultraviolet (UV) ray (dose: 500 mJ/cm²) under a nitrogen atmosphere to cure the dried second coating liquid.

### Comparative Example 2

The second coating liquid according to Example 1 was wet-coated to be 15 μm thick on a release film and dried by blowing a 90° C. wind for 2 minutes. Subsequently, the dried second coating liquid was cured by radiating an ultraviolet (UV) ray (dose: 500 mJ/cm²) under a nitrogen atmosphere, and the release film was removed, manufacturing a surface-protecting sheet.

### Comparative Example 3

A surface-protecting sheet was manufactured according to the same method as Example 1 except for not using the pentaerythritol triacrylate.

### Evaluation

The surface-protecting sheets according to Examples 1 to 4 and Comparative Examples 1 to 3 were evaluated with respect to curl generation, pencil hardness, adherence, and haze.

### Evaluation 1: Curl Generation of Surface-Protecting Sheet

Each 100 mm×100 mm square sample of the surface-protecting sheets according to Examples 1 to 4 and Comparative Examples 1 to 3 was positioned on a plane, and a maximum height that four angles of the square samples were curled up was measured.

### Evaluation 2: Pencil Hardness of Surface-Protecting Sheet

The surface-protecting sheet samples according to Examples 1 to 4 and Comparative Examples 1 to 3 were positioned on a glass plate, and pencil hardness thereof was measured by moving a load of 1000 g at a speed of 1 mm/s across the surface thereof.

### Evaluation 3: Adherence of Surface-Protecting Sheet

A 50 μm-thick OCA (MO-3005G, LINTEC Speciality Films (Korea), Inc) was respectively formed on the surface-protecting sheet samples according to Examples 1 to 4 and Comparative Examples 1 to 3, and a 25 μm-thick PET layer was formed on the OCA film.

Subsequently, the OCA film and the PET layer were peeled off from the samples with peel strength of 180° C., and adherence of the samples was evaluated.

### Evaluation 4: Haze of Surface-Protecting Sheet

Haze of the surface-protecting sheets according to Examples 1 to 4 and Comparative Examples 1 to 3 was measured by using a hazemeter (NDH-5000, Nippondenshoku Ibdustries Co. Ltd.).

The evaluation results 1 to 4 are provided in the following Table 1.

TABLE 1

| | | Pencil | Adherence | Phase | |
|---|---|---|---|---|---|
| | Curl | hardness | (N/25 mm, 180° | difference | Haze |
| | (mm) | (H) | peel) | (nm) | (%) |
| Example 1 | 3 | 4 | 16.0 | 1 | 0.4 |
| Example 2 | 9 | 4 | 16.2 | 0 | 0.4 |
| Example 3 | 5 | 7 | 15.2 | 1 | 0.4 |
| Example 4 | 3 | 4 | 15.0 | 1 | 0.4 |
| Comparative | Greater | 3 | 1.5 | 800 | 0.8 |
| Example 1 | than 40 | | | | |
| Comparative | 0 | 4 | 1.5 | 0 | 0.3 |
| Example 2 | | | | | |
| Comparative | 3 | 4 | delaminated from | 1 | 0.4 |
| Example 3 | | | an interface | | |
| | | | between the first | | |
| | | | and the second | | |
| | | | plastic substrates | | |

Referring to Table 1, the surface-protecting sheets according to Examples 1 to 4 and Comparative Examples 1 to 3 showed excellent results in the curl, pencil hardness, and adherence evaluations.

However, the surface-protecting sheet according to Comparative Example 1 showed deteriorated results for all curl generation, pencil hardness, and adherence tests compared with the surface-protecting sheets according to Examples 1 to 4.

In addition, the surface-protecting sheet according to Comparative Example 2 showed relatively satisfactory results in the curl generation and pencil hardness evaluations, but deteriorated adherence and thus, may not be appropriately used.

Furthermore, the surface-protecting sheet according to Comparative Example 3 was peeled off on the interface between the first and second plastic substrates during the adherence evaluation and may not be appropriately used.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the disclosure, including the appended claims.

<Description of Symbols>

| | |
|---|---|
| 100: surface-protecting sheet | 110: first plastic substrate |
| 120: second plastic substrate | |

What is claimed is:

1. A surface-protecting sheet, comprising:
a first plastic substrate including a thermoplastic resin and (meth)acrylic acid ester; and
a second plastic substrate disposed on one side of the first plastic substrate,
wherein the first plastic substrate has a thickness of about 0.5 μm to about 25 μm, and the second plastic substrate has a thickness of about 10 μm to about 200 μm.

2. The surface-protecting sheet of claim 1, wherein the (meth)acrylic acid ester is included in an amount of about 5 wt % to about 40 wt % based on the weight of the first plastic substrate.

3. The surface-protecting sheet of claim 2, wherein the (meth)acrylic acid ester is included in an amount of about 5 wt % to about 30 wt % based on the weight of the first plastic substrate.

4. The surface-protecting sheet of claim 1, wherein the second plastic substrate comprises an ultraviolet (UV) curable resin.

5. The surface-protecting sheet of claim 1, wherein the second plastic substrate is a hard coating layer.

6. The surface-protecting sheet of claim 1, wherein the second plastic substrate comprises (meth)acrylic acid ester.

7. The surface-protecting sheet of claim 1, wherein the second plastic substrate comprises an inorganic particle.

8. The surface-protecting sheet of claim 7, wherein a particle diameter of the inorganic particle is greater than or equal to about 10 nm and less than or equal to about 100 nm.

9. The surface-protecting sheet of claim 1, wherein the thermoplastic resin comprises polyethylene, polystyrene, polyethylene terephthalate, polyvinyl chloride, polyvinylidene chloride, a copolymer thereof, or a combination thereof.

10. The surface-protecting sheet of claim 1, wherein an adhesive layer is formed on a side of the first plastic substrate opposite a side facing the second plastic substrate.

11. The surface-protecting sheet of claim 1, wherein a surface haze of the surface-protecting sheet is less than about 1.0%.

12. A window for a display device comprising the surface-protecting sheet of claim 1.

13. A display device comprising the surface-protecting sheet of claim 1.

14. A method of producing a surface-protecting sheet, comprising
preparing a first coating liquid including a thermoplastic resin and (meth)acrylic acid ester,
coating the first coating liquid on one side of a release film and drying the same to form a first plastic substrate,
coating a second coating liquid including (meth)acrylic acid ester on the first plastic substrate followed by drying the same and radiating ultraviolet (UV) to form a second plastic substrate, and
removing the release film.

15. The method of claim 14, wherein the first coating liquid and the second coating liquid are coated using a solution casting method.

16. The method of claim 14, wherein the first plastic substrate is formed in a thickness of about 0.5 μm to about 25 μm, and the second plastic substrate is formed in a thickness of about 10 μm to about 200 μm.
